(19) United States
(12) Patent Application Publication
(10) Pub. No.: US 2019/0193775 A1
(43) Pub. Date: Jun. 27, 2019

(54) Electromotive Drive Device and Electrically-Powered Steering Device

(71) Applicant: Hitachi Automotive Systems, Ltd., Hitachinaka-shi, Ibaraki (JP)

(72) Inventor: Keiji HAMADA, Isesaki-shi, Gunma (JP)

(21) Appl. No.: 16/331,060

(22) PCT Filed: Jul. 31, 2017
(86) PCT No.: PCT/JP2017/027593

§ 371 Date: Mar. 6, 2019

(30) Foreign Application Priority Data
Sep. 12, 2016 (JP) 2016-177264

(51) Int. Cl. B62D 5/04; H02K 5/10; H02K 9/22; H02K 11/33; B23K 20/12

(52) U.S. Cl. CPC B62D 5/0406; B62D 5/046; B23K 20/122; H02K 9/22; H02K 11/33; H02K 5/10

(57) ABSTRACT

An electric drive device includes a motor housing made of aluminum-based metal and structured to house an electric motor. The motor housing includes an end face part opposite to an output part of a rotating shaft of the electric motor. An electronic control part is arranged at the end face part of the motor housing, and is configured to drive the electric motor. A metal cover is made of aluminum-based metal and structured to cover the electronic control part. One of the metal cover and the end face part of the motor housing includes an outer peripheral surface including a stepped portion having a radially inward recess form extending annularly. The stepped portion includes a fit portion where an opening portion of the metal cover is fitted. The fit portion is formed with a friction stir welding portion where the motor housing and the metal cover are welded together.

### TECHNICAL FIELD

The present invention relates generally to an electric drive device and an electric power steering device, and particularly to an electric drive device and an electric power steering device in which an electronic control unit is provided.

### BACKGROUND ART

In a general field of industrial machinery, a controlled object of a mechanical system is driven by an electric motor. In recent years, employment of an electric drive device of mechatronical integration type has been started, wherein the electric drive device includes both of an electric motor and an electronic control unit in a package, and wherein the electronic control unit includes semiconductor elements and others for controlling rotational speed and torque of the electric motor.

As an example of electric drive device of mechatronical integration type, an electric power steering device for an automotive vehicle includes an electric motor, and an electronic control unit (ECU) for controlling the electric motor, wherein the electronic control unit is configured to sense a direction and a torque of rotation of a steering shaft rotated by driver's operation of a steering wheel, and drive the electric motor based on these sensed values, to produce a steering assist torque to rotate the steering shaft in the direction of rotation of the steering shaft.

Japanese Patent Application Publication No. 2015-134598 (patent document 1) discloses a known conventional electric power steering device composed of an electric motor section and an electronic control section. In the electric motor section, an electric motor is housed in a motor housing, wherein the motor housing has a cylindrical part made of an aluminum alloy or the like. In the electronic control section, a board provided with electrical components is attached to a heat sink serving as an ECU housing, wherein the ECU housing is arranged at a side of the motor housing opposite to an output shaft of the electric motor in its axial direction. The board attached to the heat sink is provided with a power supply circuit part, a power conversion circuit part, and a control circuit part, wherein the power conversion circuit part includes power switching elements such as MOSFETs or IGBTs for driving and controlling the electric motor, and wherein the control circuit part is configured to control the power switching elements. Output terminals of the power switching elements and input terminals of the electric motor are connected electrically via a bus bar.

This electronic control part attached to the heat sink is supplied with electric power from a power supply via a connector case made of synthetic resin, and also supplied with a sensing signal indicating operating states and others from sensors and others. The connector case serves as a cover fixed to hermetically cover the heat sink, and is fixed to a surface of an outer periphery of the heat sink by fixing bolts.

Other known examples of electric drive device where an electronic control device is integrally provided include an electric brake device, and an electric hydraulic pressure control device for control of various hydraulic pressures. The following describes an electric power steering device as a representative example.

### PRIOR ART DOCUMENT(S)

### Patent Document(s)

Patent Document 1: Japanese Patent Application Publication No. 2015-134598

### SUMMARY OF THE INVENTION

### Problem(s) to be Solved by the Invention

In an electric power steering device as disclosed in patent document 1, a motor housing made of metal, a heat sink made of metal, and a connector case made of synthetic resin are fixed together by fixing bolts each of which extends through a fixing portion of each component, wherein the fixing portion projects radially outwardly. For prevention of entrance of water, O rings are disposed between the motor housing and the heat sink and between the heat sink and the connector case, respectively.

However, the provision of the fixing portions and fixing bolts at outer peripheries of the motor housing, the heat sink, and the connector case, causes an adverse effect of causing an enlargement in exterior shape and an increase in weight. The accompanying provision of the O rings for water tightness in addition to the provision of the fixing bolts, causes an adverse effect of causing an increase in number of components and an increase in manufacturing unit cost. Furthermore, although the motor housing is in intimate contact with the heat sink, the configuration that a part of intimate contact and an electronic control part are hermetically covered by the connector case made of synthetic resin that has a large thermal resistance and fails to allow preferable heat transfer and is therefore not preferable in heat dissipation property, causes an adverse effect that the connector case fails to serve for heat dissipation, and the device does not have a preferable heat dissipation property. Therefore, it is desired to provide an electric drive device and an electric power steering device where these problems are solved.

From a further auxiliary viewpoint, in an electric power steering device as disclosed in patent document 1, a heat sink member is arranged between a motor housing and an ECU housing for dissipating heat especially from a power supply circuit part and a power conversion circuit part to the outside. The provision of the heat sink member leads to enlarging the axial length of the electric power steering device. Moreover, since electrical components constituting the power supply circuit part and the power conversion circuit part generate a large quantity of heat, it is required to effectively dissipate the heat to the outside, especially when the electric power steering device is made compact. Accordingly, it is desirable to provide an electric drive device which is made as compact in the axial direction as possible and in which heat is effectively dissipated from a power supply circuit part and a power conversion circuit part to the outside.

It is a main object of the present invention to provide a new electric drive device and a new electric power steering device each of which is compact in exterior shape, and is improved in weight and number of components, and has a preferable heat dissipation property.

### Means for Solving the Problem(s)

The present invention is characterized in that: a motor housing is made of aluminum-based metal, and includes an end face part opposite to an output part of a rotating shaft of an electric motor; a metal cover is made of aluminum-based metal and structured to cover an electronic control part configured to control the electric motor; one of the metal cover and the end face part of the motor housing includes an outer peripheral surface including a stepped portion having a radially inward recess form extending annularly; the stepped portion includes a fit portion where an opening portion of the metal cover is fitted; and the fit portion is formed with a friction stir welding portion where the motor housing and the metal cover are welded together.

### Effect(s) of the Invention

According to the present invention, the feature that the end face part of the motor housing made of aluminum-based metal includes the outer peripheral surface including the stepped portion, and the stepped portion is engaged with and joined to the opening portion of the metal cover made of aluminum-based metal by friction stir welding, serves to cause a decrease in exterior shape and a decrease in weight and a decrease in number of components, by omission of fixing bolts and O rings. Moreover, the feature that the motor housing and the metal cover are welded together, serves to cause a decrease in thermal resistance and further cause the metal cover to serve for heat dissipation, and thereby cause an improvement in heat dissipation property.

### BRIEF DESCRIPTION OF THE DRAWINGS

FIG. 1 is a whole perspective view of a steering device as an example of device to which the present invention is applied.

FIG. 2 is a whole perspective view of an electric power steering device according to an embodiment of the present invention.

FIG. 3 is an exploded perspective view of the electric power steering device shown in FIG. 2.

FIG. 4 is a perspective view of a motor housing shown in FIG. 3.

FIG. 5 is a cutaway view of the motor housing shown in FIG. 4, where the motor housing is cut by a plane containing a central axis of the motor housing.

FIG. 6 is a perspective view of the motor housing shown in FIG. 4 where a power conversion circuit part is mounted and fixed to the motor housing.

FIG. 7 is a perspective view of the motor housing shown in FIG. 4 where a power supply circuit part is mounted and fixed to the motor housing.

FIG. 8 is a perspective view of the motor housing shown in FIG. 4 where a control circuit part is mounted and fixed to the motor housing.

FIG. 9 is a perspective view of the motor housing shown in FIG. 4 where a connector terminal assembly is mounted and fixed to the motor housing.

FIG. 10 is a longitudinal sectional view of a part including a place where the motor housing is joined to a metal cover.

FIG. 11 is a sectional view of a part where the joint between the motor housing and the metal cover shown in FIG. 11 is implemented by friction stir welding.

FIG. 12 is a longitudinal sectional view of a part including a place where a motor housing is joined to a metal cover, according to another embodiment.

FIG. 13 is a sectional view of a part where the joint between the motor housing and the metal cover shown in FIG. 12 is implemented by friction stir welding.

### MODE(S) FOR CARRYING OUT THE INVENTION

The following details an embodiment of the present invention with reference to the drawings. However, the present invention is not limited to the embodiment, but includes various modifications and applications belonging to technical conception of the present invention.

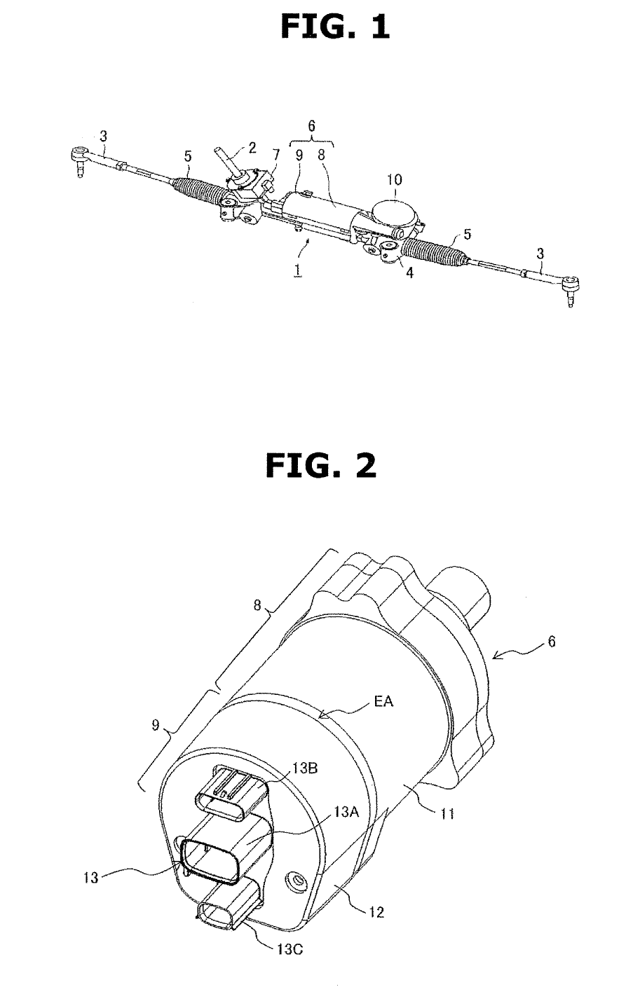

The following briefly describes configuration of a steering device as an example of device to which the present invention is applied, with reference to FIG. 1, prior to description of the embodiment of the present invention.

First, the following describes a steering device for steering front wheels of an automotive vehicle. Steering device 1 is configured as shown in FIG. 1. A steering shaft 2 is connected to a steering wheel not shown, and includes a lower end formed with a pinion not shown, wherein the pinion is in mesh with a rack not shown, wherein the rack extends in a vehicle body lateral direction. The rack includes ends linked to respective tie rods 3 for steering the front wheels leftward and rightward, and is housed by a rack housing 4. A rubber boot 5 is provided between rack housing 4 and each tie rod 3.

An electric power steering device 6 is provided for producing an assist torque while the steering wheel is being turned. Specifically, electric power steering device 6 includes a torque sensor 7, an electric motor section 8, and an electronic control section or unit (ECU) 9, wherein torque sensor 7 is structured to sense a direction of rotation of steering shaft 2, and a rotating torque applied to steering shaft 2, wherein electric motor section 8 is structured to apply a steering assist force to the rack via a gear 10 depending on a sensed value from torque sensor 7, and wherein electronic control section 9 is configured to control an electric motor arranged in electric motor section 8. Electric motor section 8 of electric power steering device 6 is connected to gear 10 by three bolts not shown at three spots of an outer peripheral part of an output shaft side of electric motor section 8. Electronic control section 9 is arranged at a side of electric motor section 8 opposite to an output shaft of electric motor section 8.

Electric power steering device 6 operates as follows. As the steering wheel is turned to rotate steering shaft 2 in one direction, torque sensor 7 then senses the direction of rotation of steering shaft 2, and the rotating torque applied to steering shaft 2. A control circuit part calculates a quantity of operation of the electric motor, based on a sensed value from torque sensor 7. Power switching elements of a power conversion circuit part are controlled to drive the electric motor based on the calculated quantity of operation, so that an output shaft of the electric motor is rotated to drive the steering shaft 2 in the same direction as the direction of operation of the steering wheel. The rotation of the output shaft of the electric motor is transferred to the rack via the pinion and gear 10, thereby steering the automotive vehicle. Further description is omitted because its configuration and operation are well known.

As described above, in an electric power steering device as disclosed in patent document 1, a motor housing made of metal, a heat sink made of metal, and a connector case made of synthetic resin are fixed together by fixing bolts each of which extends through a fixing portion of each component, wherein the fixing portion projects radially outwardly. For prevention of entrance of water, O rings are disposed between the motor housing and the heat sink and between the heat sink and the connector case, respectively.

The provision of the fixing portions and fixing bolts at outer peripheries of the motor housing, the heat sink, and the connector case, causes an adverse effect of causing an enlargement in exterior shape and an increase in weight. The accompanying provision of the O rings for water tightness in addition to the provision of the fixing bolts, causes an adverse effect of causing an increase in number of components and an increase in manufacturing unit cost. Furthermore, although the motor housing is in intimate contact with the heat sink, the configuration that a part of intimate contact and an electronic control part are hermetically covered by the connector case made of synthetic resin that has a large thermal resistance and fails to allow preferable heat transfer and is therefore not preferable in heat dissipation property, causes an adverse effect that the connector case fails to serve for heat dissipation, and the device does not have a preferable heat dissipation property.

In view of the foregoing background, according to the present embodiment, an electric power steering device is proposed which is configured as follows. Specifically, according to the present embodiment: a motor housing is made of aluminum-based metal, and includes an end face part opposite to an output part of a rotating shaft of an electric motor; a metal cover is made of aluminum-based metal and structured to cover an electronic control part configured to control the electric motor; the end face part of the motor housing includes an outer peripheral surface including a stepped portion having a radially inward recess form extending annularly; the stepped portion includes a fit portion where an opening portion of the metal cover is fitted; and the fit portion is formed with a friction stir welding portion where the motor housing and the metal cover are welded together.

The feature that the end face part of the motor housing made of aluminum-based metal includes the outer peripheral surface including the stepped portion, and the stepped portion is engaged with and joined to the opening portion of the metal cover made of aluminum-based metal by friction stir welding, serves to cause a decrease in exterior shape and a decrease in weight and a decrease in number of components, by omission of fixing bolts and O rings. Moreover, the feature that the motor housing and the metal cover are welded together, serves to cause a decrease in thermal resistance and further cause the metal cover to serve for heat dissipation, and thereby cause an improvement in heat dissipation property.

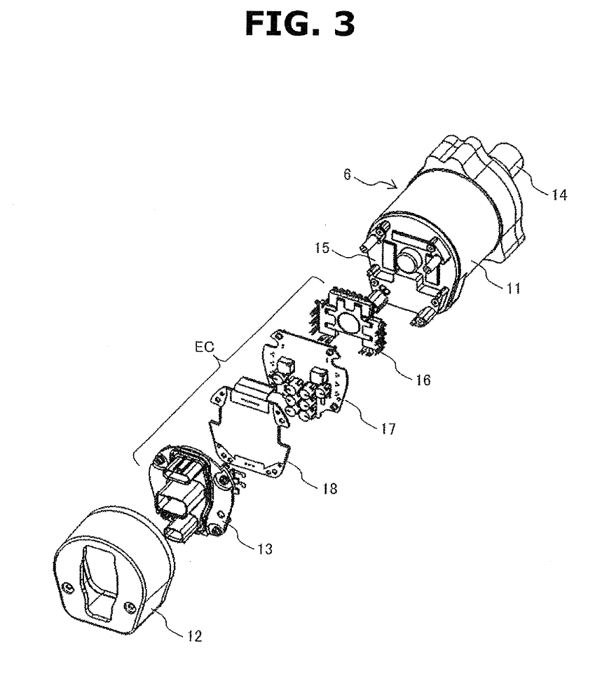

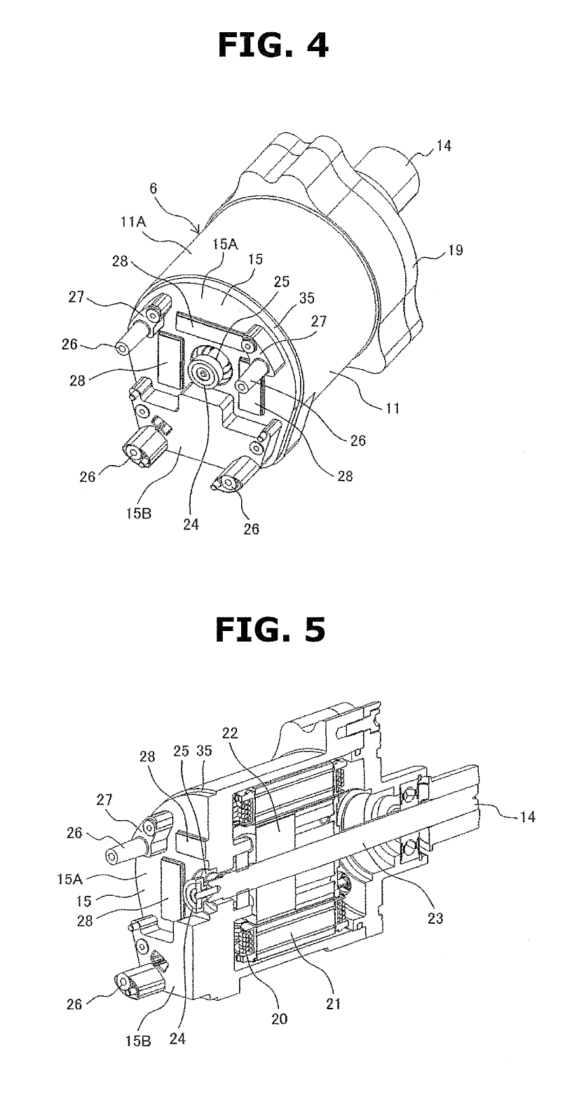

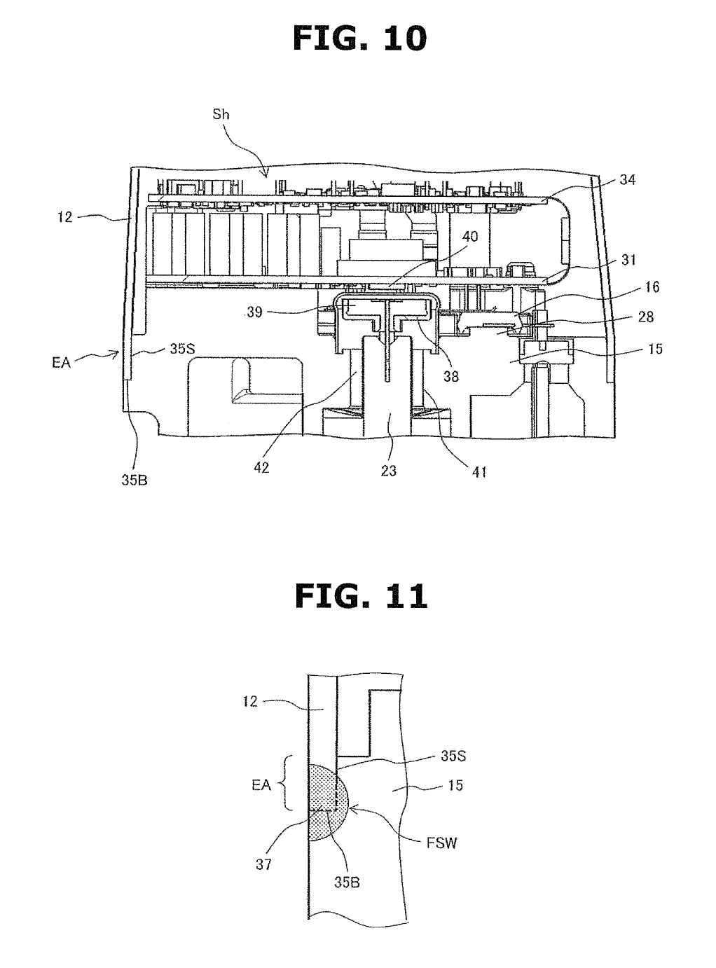

The following details specific configuration of the electric power steering device according to the embodiment of the present invention with reference to FIGS. 2 to 10. FIG. 2 shows whole configuration of the electric power steering device according to the present embodiment. FIG. 3 shows components of the electric power steering device shown in FIG. 2 in disassembled state as viewed diagonally. FIGS. 4 to 9 show states of assembling when the components are assembled in an assembling order. FIG. 10 is a longitudinal sectional view of a part including a place where the motor housing is joined to a metal cover. The following description refers to these drawings as appropriate.

As shown in FIG. 2, the electric power steering device includes electric motor section 8 and electronic control section 9. Electric motor section 8 includes a motor housing 11 and an electric motor not shown. Motor housing 11 includes a cylindrical part made of an aluminum-based metal such as aluminum or an aluminum alloy. The electric motor is housed in motor housing 11. Electronic control section 9 includes a metal cover 12, and an electronic control assembly not shown housed in metal cover 12. Metal cover 12 is made of an aluminum-based metal such as aluminum or an aluminum alloy, and is arranged at a side of motor housing 11 opposite to the output shaft in the axial direction.

Motor housing 11 and metal cover 12 are fixed to each other by friction stir welding in a circumferential fit region EA of their end faces facing each other, wherein circumferential fit region EA extends circumferentially, as detailed below. Metal cover 12 includes an accommodation space inside thereof, which accommodates the electronic control assembly. The electronic control part includes a power supply circuit part for supplying electric power as required, and a power conversion circuit part having power switching elements such as MOSFETs or IGBTs for driving and controlling the electric motor of electric motor section 8, and a control circuit part for controlling the power switching elements. Output terminals of the power switching elements and input terminals of a coil of the electric motor are connected electrically via a bus bar.

At an end face of metal cover 12 opposite to motor housing 11, a connector terminal assembly 13 is exposed through a hole of metal cover 12. Connector terminal assembly 13 is fixed to a fixing portion of motor housing 11 by fixing bolts. Connector terminal assembly 13 includes a connector terminal forming part 13A for power supply, a connector terminal forming part 13B for sensors, and a connector terminal forming part 13C for sending a state of control to external devices.

The electronic control assembly housed in metal cover 12 is supplied with electric power from a power supply via the connector terminal forming part 13A made of synthetic resin, and is supplied with sensing signals indicative of operating states from sensors and others via the connector terminal forming part 13B, and sends a present control state of the electric power steering device via the connector terminal forming part 13C.

FIG. 3 shows electric power steering device 6 in exploded perspective view. Inside of motor housing 11, a side yoke not shown is fitted, wherein the side yoke has an annular shape and is made of iron. The electric motor not shown is mounted inside of the side yoke. The electric motor includes an output part 14 structured to apply a steering assist force to the rack via the gear. Description of specific configuration of the electric motor is omitted because it is well known.

Motor housing 11 is made of an aluminum alloy, thereby serving as a heat sink member for dissipating heat to outside atmosphere, wherein the heat is generated by the power conversion circuit part and the power supply circuit part described below. The electric motor and motor housing 11 form the electric motor section.

Electronic control part EC is attached to an end face part 15 of motor housing 11 opposite to the output part 14 of electric motor section 8. Electronic control part EC includes power conversion circuit part 16, power supply circuit part 17, control circuit part 18, and connector terminal assembly 13. The end face part 15 of motor housing 11 is formed integrally with motor housing 11, but may be formed separately from motor housing 11 and bolted or welded to motor housing 11.

Power conversion circuit part 16, power supply circuit part 17, and control circuit part 18 form redundant systems, namely, a main electronic control system and an auxiliary electronic control system. Normally, the main electronic control system is employed to drive and control the electric motor, and when an abnormality or failure occurs in the main electronic control system, the control is switched from the main electronic control system to the auxiliary electronic control system so that the auxiliary electronic control system drives and controls the electric motor.

Accordingly, as detailed below, heat of the main electronic control system is normally transferred to motor housing 11. When the main electronic control system is failed or abnormal, operation of the main electronic control system is stopped and the auxiliary electronic control system is operated so that heat of the auxiliary electronic control system is transferred to motor housing 11.

However, although not adopted by the present embodiment, there is an alternative configuration that both of the main and auxiliary electronic control systems are simultaneously employed to form a normal electronic control system, and when one of the main and auxiliary electronic control systems is failed or abnormal, only the other electronic control system is employed to drive and control the electric motor with half of full performance. This ensures a limp-home function, although the performance of the electric motor is only half. Accordingly, the heat of the main electronic control system and the auxiliary electronic control system is normally transferred to motor housing 11.

Electronic control part EC is composed of power conversion circuit part 16, power supply circuit part 17, control circuit part 18, and connector terminal assembly 13, which are arranged in this order away from end face part 15 of motor housing 11. Control circuit part 18 is configured to generate control signals for driving the switching elements of power conversion circuit part 16, and includes a microcomputer and a peripheral circuit. Power supply circuit part 17 is configured to supply electric power to power conversion circuit part 16, and includes a capacitor, a coil, switching elements, and others. Power conversion circuit part 16 is configured to regulate electric power flowing through the coil of the electric motor, and includes switching elements and others forming three-phase upper and lower arms.

In electronic control part EC, power conversion circuit part 16 and power supply circuit part 17 generate more quantities of heat than others. The generated heat of power conversion circuit part 16 and power supply circuit part 17 is dissipated via motor housing 11 made of the aluminum alloy. This configuration is detailed below.

Connector terminal assembly 13, which is made of synthetic resin, is arranged between control circuit part 18 and metal cover 12, and is connected to a vehicle battery (power supply) and external control devices not shown. Connector terminal assembly 13 is also connected to power conversion circuit part 16, power supply circuit part 17, and control circuit part 18.

Metal cover 12 functions to house and seal liquid-tightly the power conversion circuit part 16, power supply circuit part 17, and control circuit part 18. In the present embodiment, metal cover 12 is fixed to motor housing 11 by friction stir welding.

This feature serves to allow the exterior shape to be made compact by omission of fixing bolts, and allow fixing bolts and O rings for water tightness to be omitted. Moreover, the feature that motor housing 11 and metal cover 12 are welded together, serves to cause a decrease in thermal resistance and thereby enhance heat transfer capability between motor housing 11 and metal cover 12. The further feature that metal cover 12 is made of metal serves to allow generated heat of power conversion circuit part 16, power supply circuit part 17, etc. to the outside.

The following describes configuration of the components and a process of assembling the components with reference to FIGS. 4 to 9. FIG. 4 shows an exterior view of motor housing 11, and FIG. 5 shows its axial sectional view. As shown in FIGS. 4 and 5, motor housing 11 is cylindrically shaped and includes a lateral peripheral surface part 11A, end face part 15, and an end face part 19. The end face part 15 closes a first end of lateral peripheral surface part 11A, whereas the end face part 19 closes a second end of lateral peripheral surface part 11A. In the present embodiment, lateral peripheral surface part 11A and end face part 15 are formed integrally such that motor housing 11 has a cylindrical shape having a bottom. The end face part 19 serves as a cover for covering the second end of lateral peripheral surface part 11A after the electric motor is mounted inside the lateral peripheral surface part 11A.

End face part 15 includes an end portion including an outer peripheral surface including a stepped portion 35 having a radially inward recess form extending annularly. Stepped portion 35 is fitted with an opening portion of metal cover 12. The fitting is shown as a circumferential fit region EA in FIG. 2. The form of fitting between stepped portion 35 and the opening portion of metal cover 12 is referred to as “spigot engagement” or “spigot fitting”.

As shown in FIG. 5, a stator 21 is fitted inside the lateral peripheral surface part 11A, wherein stator 21 is formed by winding the coil 20 around an iron core. A rotor 22 is rotatably mounted inside the stator 21, wherein a permanent magnet is embedded in rotor 22. A rotating shaft 23 is fixed to rotor 22. One end of rotating shaft 23 forms the output part 14, whereas the other end of rotating shaft 23 forms a rotation-sensing target part 24 serving as a target for sensing the rotational phase and speed of rotating shaft 23. Rotation-sensing target part 24 is provided with a permanent magnet, extending through a through hole 25 formed in end face part 15, and projecting to the outside. The rotational phase and speed of rotating shaft 23 is sensed by a magnet-sensing part such as a GMR element or the like not shown.

Referring back to FIG. 4, the surface of end face part 15 opposite to the output part 14 of rotating shaft 23 is formed with heat dissipation regions 15A and 15B for power conversion circuit part 16 (see FIG. 3) and power supply circuit part 17 (see FIG. 3), which is a characterizing feature. Four corners of end face part 15 are formed integrally with board-connector-fixing projecting parts 26, each of which extends perpendicularly from end face part 15. Each board-connector-fixing projecting part 26 is formed with a threaded hole inside. Board-connector-fixing projecting parts 26 are configured to fix a board of control circuit part 18 described below and connector terminal assembly 13. Each board-fixing projecting part 26 projecting from power conversion part heat dissipation region 15A described below is formed with a board-receiving part 27 having the same height as power supply part heat dissipation region 15B described below in the axial direction. Each board-receiving part 27 is configured to mount and fix a glass epoxy board 31 of power supply circuit part 17 described below. The flat area forming the end face part 15 and extending in the radial direction and perpendicular to rotating shaft 23 is divided into two regions, namely, power conversion part heat dissipation region 15A and power supply part heat dissipation region 15B. Power conversion circuit part 16 is attached to power conversion part heat dissipation region 15A. Power supply circuit part 17 is attached to power supply part heat dissipation region 15B. In the present embodiment, the area of power conversion part heat dissipation region 15A is set larger than that of power supply part heat dissipation region 15B, for ensuring more space for mounting the power conversion circuit part 16, because power conversion circuit part 16 includes redundant systems as described above, and thereby requires a sufficient mounting space.

There is a step between power conversion part heat dissipation region 15A and power supply part heat dissipation region 15B such that power conversion part heat dissipation region 15A and power supply part heat dissipation region 15B have different heights in the axial direction (the direction in which rotating shaft 23 extends). Namely, power supply part heat dissipation region 15B is formed with an outward step away with respect to power conversion part heat dissipation region 15A in the axial direction of rotating shaft 23 of the electric motor. This step is set to have a height enough to prevent interference between power conversion circuit part 16 and power supply circuit part 17 when power supply circuit part 17 is assembled after power conversion circuit part 16 is assembled.

Power conversion part heat dissipation region 15A is formed with three heat dissipation projecting parts 28, wherein each heat dissipation projecting part 28 has a narrow rectangular shape. Heat dissipation projecting parts 28 are configured to mount power conversion circuit part 16 thereon, wherein power conversion circuit part 16 described below has redundant systems. Each heat dissipation projecting part 28 projects away from the electric motor in the direction of rotating shaft 23 of the electric motor.

Power supply part heat dissipation region 15B is generally flat and is configured to mount power supply circuit part 17 thereon, where power supply circuit part 17 is described below. Accordingly, each heat dissipation projecting part 28 serves as a heat dissipation part to transfer heat from power conversion circuit part 16 to end face part 15, whereas power supply part heat dissipation region 15B serves as a heat dissipation part to transfer heat from power supply circuit part 17 to end face part 15.

Each heat dissipation projecting part 28 may be omitted so that power conversion part heat dissipation region 15A serves as a heat dissipation part to transfer heat from power conversion circuit part 16 to end face part 15. However, in the present embodiment, each metal board of power conversion circuit part 16 is welded and securely fixed to heat dissipation projecting part 28 by friction stir welding.

At end face part 15 of motor housing 11 according to the present embodiment described above, the axial size can be made compact because there is no heat sink member. Moreover, since motor housing 11 has a sufficient thermal capacity, the heat generated in power supply circuit part 17 and power conversion circuit part 16 can be dissipated to the outside effectively.

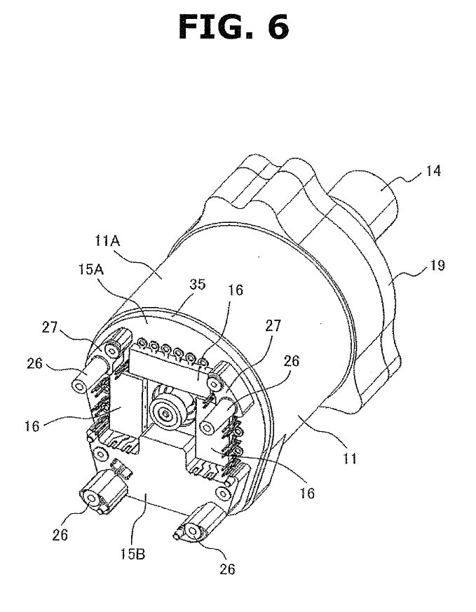

FIG. 6 shows a state where power conversion circuit part 16 is placed on heat dissipation projecting parts 28 (see FIG. 4). As shown in FIG. 6, power conversion circuit part 16 composed of redundant systems is placed on heat dissipation projecting parts 28 (see FIG. 4) formed in power conversion part heat dissipation region 15A. The switching elements constituting the power conversion circuit part 16 are placed on a metal board, which is made of an aluminum-based metal material in this example, allowing their generated heat to be dissipated effectively. The metal board is welded to heat dissipation projecting part 28 by friction stir welding.

In this way, the metal board is securely fixed to heat dissipation projecting parts 28 (see FIG. 4), to allow generated heat of the switching elements to be transferred to heat dissipation projecting parts 28 (see FIG. 4) effectively. The heat transferred to heat dissipation projecting parts 28 (see FIG. 4) is dissipated to power conversion part heat dissipation region 15A, and then to lateral peripheral surface part 11A of motor housing 11, and finally to the outside. As described above, power conversion circuit part 16 is prevented from interfering with power supply circuit part 17 described below, because the height of power conversion circuit part 16 is shorter than that of power supply part heat dissipation region 15B in the axial direction.

In this way, power conversion circuit part 16 is placed on heat dissipation projecting parts 28 of power conversion part heat dissipation region 15A. This allows the generated heat of the switching elements of power conversion circuit part 16 to be transferred to heat dissipation projecting parts 28 effectively. The heat transferred to heat dissipation projecting parts 28 is dissipated to power conversion part heat dissipation region 15A, and then to lateral peripheral surface part 11A of motor housing 11, and finally to the outside.

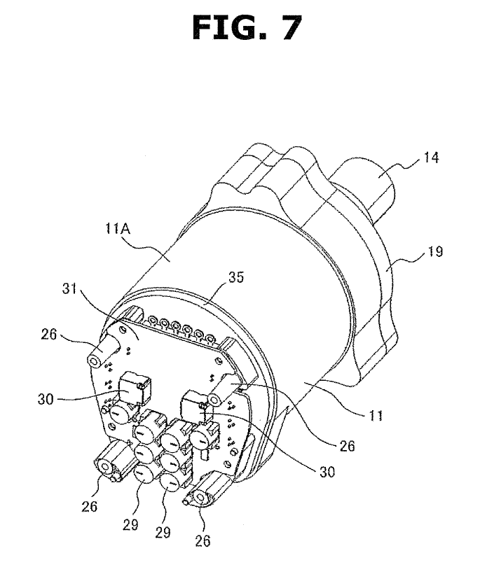

FIG. 7 shows a state where power supply circuit part 17 is placed over power conversion circuit part 16. As shown in FIG. 7, power supply part heat dissipation region 15B is covered by power supply circuit part 17. Power supply circuit part 17 includes glass epoxy board 31, and capacitors 29, coils 30 and others placed on glass epoxy board 31. Power supply circuit part 17 includes redundant systems, each of which includes a power supply circuit composed of capacitors 29 and coil 30 and arranged symmetrically with each other as shown in FIG. 7.

The surface of glass epoxy board 31 facing the power supply part heat dissipation region 15B (see FIG. 6) is fixed to end face part 15 in contact with power supply part heat dissipation region 15B. As shown in FIG. 7, this fixing is implemented by bolting with a fixing bolt not shown through a threaded hole formed in each board-receiving part 27 of board-fixing projecting part 26, and also with a fixing bolt not shown through a threaded hole formed in power supply part heat dissipation region 15B (see FIG. 6).

The configuration that power supply circuit part 17 is based on glass epoxy board 31 allows the components of power supply circuit part 17 to be mounted on both sides of the power supply circuit part 17. The surface of glass epoxy board 31 facing the power supply part heat dissipation region 15B (see FIG. 6) is provided with a sensing part for sensing the rotational phase and speed of rotating shaft 23 (see FIG. 5) in cooperation with rotation-sensing target part 24 (see FIG. 5) of rotating shaft 23, wherein the sensing part includes a GMR element and a sensing circuit not shown.

The configuration that glass epoxy board 31 is fixed to power supply part heat dissipation region 15B (see FIG. 6) in contact with power supply part heat dissipation region 15B as described above, allows the generated heat of power supply circuit part 17 to be transferred to power supply part heat dissipation region 15B effectively. The heat transferred to power supply part heat dissipation region 15B (see FIG. 6) is transferred and spread into lateral peripheral surface part 11A of motor housing 11, and then dissipated to the outside. In order to enhance the thermal conductivity, an adhesive agent or dissipation grease or dissipation sheet having a high thermal conductivity may be disposed between glass epoxy board 31 and power supply part heat dissipation region 15B (see FIG. 6).

In this way, power supply circuit part 17 is placed on the upper side of power supply part heat dissipation region 15B. The surface of glass epoxy board 31 of power supply circuit part 17 facing the power supply part heat dissipation region 15B, on which the circuit elements of power supply circuit part 17 are placed, is fixed to end face part 15 in contact with power supply part heat dissipation region 15B. This allows the generated heat of power supply circuit part 17 to be transferred to power supply part heat dissipation region 15B effectively. The heat transferred to power supply part heat dissipation region 15B is transferred to and spread in lateral peripheral surface part 11A of motor housing 11, and dissipated to the outside.

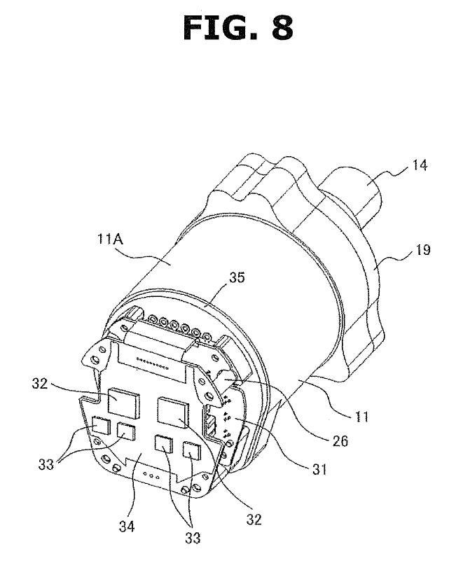

FIG. 8 shows a state where control circuit part 18 is placed over the power supply circuit part 17. As shown in FIG. 8, electric motor section 8 is arranged over power supply circuit part 17. Microcomputers 32 and peripheral circuits 33 constituting the control circuit part 18 are placed on glass epoxy board 34. Control circuit part 18 includes redundant systems, each of which includes a control circuit composed of microcomputer 32 and peripheral circuits 33 and arranged symmetrically with each other as shown in FIG. 8.

Microcomputers 32 and peripheral circuits 33 may be placed on the surface of glass epoxy board 34 facing the power supply circuit part 17.

As shown in FIG. 8, glass epoxy board 34 is fixed by fixing bolts not shown through the threaded holes formed in the top portions of board-fixing projecting parts 26 (see FIG. 7), wherein glass epoxy board 34 is sandwiched between board-fixing projecting parts 26 and connector terminal assembly 13.

The space between glass epoxy board 31 of power supply circuit part 17 (see FIG. 7) and glass epoxy board 34 of control circuit part 18 is used for arrangement of capacitors 29, coils 30 and others of power supply circuit part 17 shown in FIG. 7.

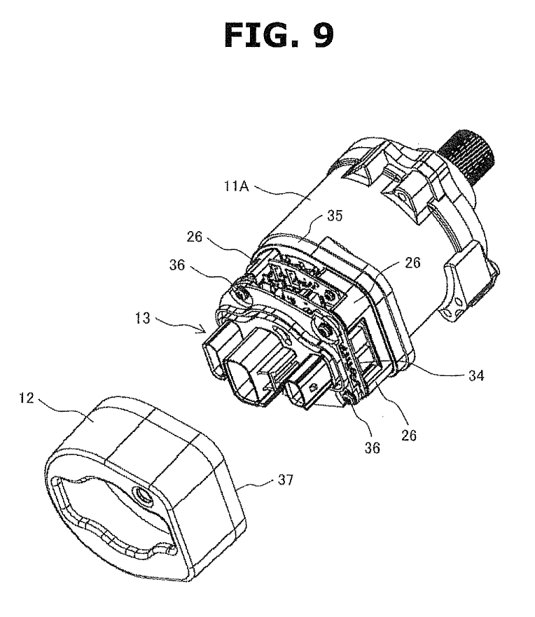

FIG. 9 shows a state where connector terminal assembly 13 is placed over the control circuit part 18. As shown in FIG. 9, connector terminal assembly 13 is arranged over control circuit part 18. Connector terminal assembly 13 is fixed by fixing bolts 36 through the threaded holes formed in the top portions of board-fixing projecting parts 26, sandwiching the control circuit part 18. Under this condition, connector terminal assembly 13 is connected to power conversion circuit part 16, power supply circuit part 17, and control circuit part 18, as shown in FIG. 3, and opening portion 37 of metal cover 12 is fitted with stepped portion 35 of motor housing 11 by spigot fitting or the like, and is welded to stepped portion 35 of motor housing 11 in circumferential fit region EA by friction stir welding, thereby sealing liquid-tightly power conversion circuit part 16, power supply circuit part 17, and control circuit part 18.

FIG. 10 shows a part including the circumferential fit region EA of motor housing 11 and metal cover 12 in its longitudinal sectional view. In FIG. 10, electronic control part EC is arranged adjacent to end face part 15 of motor housing 11, and is covered by metal cover 12, and is thereby accommodated in an accommodation space Sh formed by metal cover 12 and end face part 15. A magnet hold part 38 is fixed to the end part of rotating shaft 23 opposite to output part 14, wherein a permanent magnet (sensor magnet) 39 is housed in and fixed to magnet hold part 38, wherein permanent magnet 39 forms the rotation-sensing target part.

The end part of rotating shaft 23, magnet hold part 38, and permanent magnet 39 project toward the electronic control part EC with respect to end face part 15 of motor housing 11. A magnetic sensor 40 such as a GMR element is fixed to the surface of glass epoxy board 31 of power supply circuit part 17 facing the motor housing 11, wherein power supply circuit part 17 is arranged in electronic control part EC. Magnetic sensor 40 has a magnet-sensing function and is configured to sense the rotational phase or the like of rotating shaft 23 based on rotation of permanent magnet 39. A ball bearing 42 is provided in a through hole 41 and is structured to support the rotating shaft 23 rotatably, wherein through hole 41 is formed at or near a center of end face part 15, and wherein rotating shaft 23 extends through the through hole 41.

As shown in FIGS. 10 and 11, stepped portion 35 formed in the outer peripheral surface of end face part 15 includes a stepped portion side wall 35S and a stepped portion bottom wall 35B, wherein stepped portion side wall 35S is formed by radially inwardly recessing, and wherein stepped portion bottom wall 35B connects stepped portion side wall 35S to lateral peripheral surface part 11A of end face part 15. Stepped portion 35 composed of stepped portion bottom wall 35B and stepped portion side wall 35S is fitted with opening portion 37 of metal cover 12 by spigot fitting. The portion of contact between stepped portion side wall 35S and metal cover 12 forms the circumferential fit region EA.

As shown in FIG. 11, a process of friction stir welding is applied to a part including a central region where stepped portion bottom wall 35B is in contact with opening portion 37 of metal cover 12 (i.e. where stepped portion bottom wall 35B is butted with opening portion 37 of metal cover 12). Specifically, a region of contact between stepped portion bottom wall 35B and a distal end of opening portion 37 of metal cover 12, and a region of contact between stepped portion side wall 35S and a part of an inner periphery of opening portion 37 of metal cover 12 are welded together by friction stir welding, thereby forming a friction stir welding portion FSW.

In FIG. 11, the welded portion extends deeply and includes the region of contact between stepped portion side wall 35S and the inner periphery of opening portion 37 of metal cover 12, but this configuration may be modified such that the welded portion extends shallowly and includes only the region of contact between stepped portion bottom wall 35B and the distal end of opening portion 37 of metal cover 12.

In general, friction stir welding is implemented by: pressing, with great effort, a tool onto a joint portion between members to be joined, wherein the tool has a cylindrical shape having a distal end including a projecting portion, while rotating the tool; thereby causing the projecting portion of the tool to intrude into the joint portion; generating frictional heat and soften workpieces; causing a plastic flow of the joint portion and its surroundings by power of rotation of the tool; and thereby mixing and integrating the members together.

In this way, according to the present embodiment, the outer peripheral surface of end face part 15 of motor housing 11 made of aluminum-based metal includes the stepped portion 35 having a radially inward recess form, and opening portion 37 of metal cover 12 made of aluminum-based metal is fitted with stepped portion 35, and this circumferential fit region EA is formed with friction stir welding portion FSW where motor housing 11 and metal cover 12 are welded together.

The feature that stepped portion 35 of the outer peripheral surface of end face part 15 of the motor housing is fitted with and joined to opening portion 37 of metal cover 12 by friction stir welding, serves to cause a decrease in exterior shape and a decrease in weight and a decrease in number of components, by omission of fixing bolts and O rings. Moreover, the feature that motor housing 11 and metal cover 12 are welded together, serves to cause a decrease in thermal resistance and further cause the metal cover to serve for heat dissipation, and thereby cause an improvement in heat dissipation property. The integration of metal cover 12 and motor housing 11 serves to provide a large heat capacity, and thereby cause a further improvement in heat dissipation property.

In addition, according to the present embodiment, power conversion circuit part 16 is placed on the upper side of heat dissipation projecting part 28 formed in power conversion part heat dissipation region 15A. This allows the generated heat of the switching elements of power conversion circuit part 16 to be transferred to heat dissipation projecting part 28 effectively. Furthermore, the heat transferred to heat dissipation projecting part 28 is spread in power conversion part heat dissipation region 15A, and transferred to lateral peripheral surface part 11A of motor housing 11, and dissipated to the outside.

Similarly, power supply circuit part 17 is placed on the upper side of power supply part heat dissipation region 15B. The surface of glass epoxy board 31 of power supply circuit part 17 facing the power supply part heat dissipation region 15B, on which the circuit elements of power supply circuit part 17 are placed, is fixed to end face part 15 in contact with power supply part heat dissipation region 15B. This allows the generated heat of power supply circuit part 17 to be transferred to power supply part heat dissipation region 15B effectively. The heat transferred to power supply part heat dissipation region 15B is transferred to and spread in lateral peripheral surface part 11A of motor housing 11, and dissipated to the outside.

With the configuration described above, the heat generated in power supply circuit part 17 and power conversion circuit part 16 is transferred to end face part 15 of motor housing 11, allowing to omit a heat sink member, and thereby shorten the axial size. Moreover, since motor housing 11 has a sufficient thermal capacity, the heat generated in the power supply circuit part and the power conversion circuit part can be dissipated to the outside effectively.

As described above, the present invention is exemplified by a configuration: a motor housing is made of aluminum-based metal, and includes an end face part opposite to an output part of a rotating shaft of an electric motor; a metal cover is made of aluminum-based metal and structured to cover an electronic control part configured to control the electric motor; the end face part of the motor housing includes an outer peripheral surface including a stepped portion having a radially inward recess form; an opening portion of the metal cover is fitted with the stepped portion; and this portion of fitting is formed with a friction stir welding portion where the motor housing and the metal cover are welded together.

The feature that the stepped portion of the motor housing is engaged with and joined to the opening portion of the metal cover by friction stir welding, serves to cause a decrease in exterior shape and a decrease in weight and a decrease in number of components, by omission of fixing bolts and O rings. Moreover, the feature that the motor housing and the metal cover are welded together, serves to cause a decrease in thermal resistance and further cause the metal cover to serve for heat dissipation, and thereby cause an improvement in heat dissipation property.

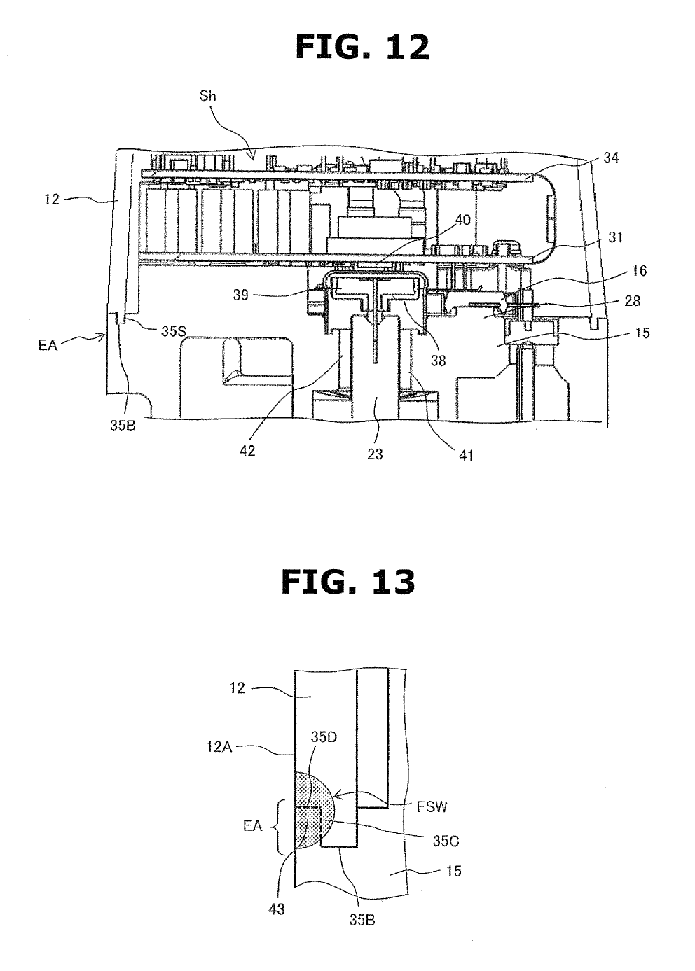

FIGS. 12 and 13 show another embodiment. This embodiment differs from the foregoing embodiment in that the stepped portion is formed in the metal cover, wherein the remaining configuration is the same as in the foregoing embodiment. As shown in FIGS. 12 and 13, metal cover 12 includes an outer peripheral surface including a stepped portion 35, wherein stepped portion 35 includes a stepped portion side wall 35C and a stepped portion connection wall 35D, wherein stepped portion side wall 35C is formed by radially inwardly recessing, and wherein stepped portion connection wall 35D connects stepped portion side wall 35S to a lateral peripheral surface part 12A of metal cover 12. Stepped portion 35 composed of stepped portion connection wall 35D and stepped portion side wall 35C is fitted with an opening portion 43 of motor housing 11 by spigot fitting. The portion of contact between stepped portion side wall 35C and opening portion 43 of motor housing 11 forms a circumferential fit region EA.

As shown in FIG. 13, a process of friction stir welding is applied to a part including a central region where stepped portion connection wall 35D is in contact with opening portion 43 of motor housing 11 (i.e. where stepped portion connection wall 35D is butted with opening portion 43 of motor housing 11).

Specifically, a region of contact between stepped portion connection wall 35D and a distal end of opening portion 43 of motor housing 11, and a region of contact between stepped portion side wall 35C and a part of an inner periphery of opening portion 43 of motor housing 11 are welded together by friction stir welding, thereby forming a friction stir welding portion FSW. The present embodiment produces similar advantageous effects, similar to the first embodiment.

The present invention is not limited to the embodiment described above, but includes various modified embodiments. The described embodiment is detailed merely for easy understanding of the present invention, and the present invention is not limited to a form including all of the features described above, for example. Part of features of one of the embodiments may be replaced with features of another one of the embodiments. Features of one of the embodiments may be additionally provided with features of another one of the embodiments. Part of features of each of the embodiments may be additionally provided with other features or removed or replaced.

The electric drive device according to the embodiment described above may be exemplified as follows.

According to one aspect, an electric drive device includes: a motor housing made of aluminum-based metal and structured to house an electric motor, wherein the motor housing includes an end face part opposite to an output part of a rotating shaft of the electric motor, and wherein the electric motor is structured to drive a controlled object of a mechanical system; an electronic control part arranged at the end face part of the motor housing, and configured to drive the electric motor, wherein the electronic control part includes a control circuit part, a power supply circuit part, and a power conversion circuit part; and a metal cover made of aluminum-based metal and structured to cover the electronic control part; wherein one of the metal cover and the end face part of the motor housing includes an outer peripheral surface including a stepped portion having a radially inward recess form extending annularly; the stepped portion includes a fit portion where an opening portion of the metal cover is fitted; and the fit portion is formed with a friction stir welding portion where the motor housing and the metal cover are welded together.

According to a preferable aspect, the electric drive device is configured such that: the end face part of the motor housing includes the outer peripheral surface including the stepped portion; the stepped portion includes a stepped portion side wall and a stepped portion bottom wall, wherein the stepped portion side wall is recessed radially inwardly, and wherein the stepped portion bottom wall connects the stepped portion side wall to a lateral peripheral surface part of the end face part; the opening portion of the metal cover is fitted with the stepped portion by spigot fitting; and the friction stir welding portion has a central region where the stepped portion bottom wall and the opening portion of the metal cover are in contact with each other.

According to another preferable aspect, the electric drive device according to one of the foregoing aspects is configured such that the friction stir welding portion extends in a region of contact between the stepped portion bottom wall and a distal end of the opening portion of the metal cover, and in a region of contact between the stepped portion side wall and part of an inner periphery of the opening portion of the metal cover.

According to a further preferable aspect, the electric drive device according to one of the foregoing aspects is configured such that: the end face part of the motor housing includes a power conversion part heat dissipation region and a power supply part heat dissipation region; the power conversion circuit part is mounted to the power conversion part heat dissipation region in a manner to allow generated heat of the power conversion circuit part to be transferred to the motor housing via the power conversion part heat dissipation region; and the power supply circuit part is mounted to the power supply part heat dissipation region in a manner to allow generated heat of the power supply circuit part to be transferred to the motor housing via the power supply part heat dissipation region.

According to a further preferable aspect, the electric drive device according to one of the foregoing aspects is configured such that the end face part of the motor housing includes a step between the power supply part heat dissipation region and the power conversion part heat dissipation region such that the power supply part heat dissipation region projects away from the electric motor in an axial direction of the electric motor with respect to the power conversion part heat dissipation region.

According to a further preferable aspect, the electric drive device according to one of the foregoing aspects is configured such that the power conversion part heat dissipation region includes a heat dissipation projecting part projecting away from the electric motor in the axial direction of the electric motor.

According to a further preferable aspect, the electric drive device according to one of the foregoing aspects is configured such that the power conversion circuit part, the power supply circuit part, and the control circuit part of the electronic control part are arranged in this order away from the electric motor in the axial direction of the electric motor.

The electric power steering device according to the embodiment described above may be exemplified as follows.

According to one aspect, an electric power steering device includes: an electric motor structured to apply a steering assist force to a steering shaft, depending on an output from a torque sensor, wherein the torque sensor is structured to sense a direction of rotation of the steering shaft and a rotating torque applied to the steering shaft; a motor housing structured to house the electric motor, wherein the motor housing includes an end face part opposite to an output part of a rotating shaft of the electric motor; an electronic control part arranged at the end face part of the motor housing, and configured to drive the electric motor, wherein the electronic control part includes a control circuit part, a power supply circuit part, and a power conversion circuit part; a metal cover made of aluminum-based metal and structured to cover the electronic control part; wherein one of the metal cover and the end face part of the motor housing includes an outer peripheral surface including a stepped portion having a radially inward recess form extending annularly; the stepped portion includes a fit portion where an opening portion of the metal cover is fitted; and the fit portion is formed with a friction stir welding portion where the motor housing and the metal cover are welded together.

According to a preferable aspect, the electric power steering device is configured such that: the end face part of the motor housing includes the outer peripheral surface including the stepped portion; the stepped portion includes a stepped portion side wall and a stepped portion bottom wall, wherein the stepped portion side wall is recessed radially inwardly, and wherein the stepped portion bottom wall connects the stepped portion side wall to a lateral peripheral surface part of the end face part; the opening portion of the metal cover is fitted with the stepped portion by spigot fitting; and the friction stir welding portion has a central region where the stepped portion bottom wall and the opening portion of the metal cover are in contact with each other.

According to another preferable aspect, the electric power steering device according to one of the foregoing aspects is configured such that the friction stir welding portion extends in a region of contact between the stepped portion bottom wall and a distal end of the opening portion of the metal cover, and in a region of contact between the stepped portion side wall and part of an inner periphery of the opening portion of the metal cover.

According to a further preferable aspect, the electric power steering device according to one of the foregoing aspects is configured such that: the end face part of the motor housing includes a power conversion part heat dissipation region and a power supply part heat dissipation region; the power conversion circuit part is mounted to the power conversion part heat dissipation region in a manner to allow generated heat of the power conversion circuit part to be transferred to the motor housing via the power conversion part heat dissipation region; and the power supply circuit part is mounted to the power supply part heat dissipation region in a manner to allow generated heat of the power supply circuit part to be transferred to the motor housing via the power supply part heat dissipation region.

According to a further preferable aspect, the electric power steering device according to one of the foregoing aspects is configured such that the end face part of the motor housing includes a step between the power supply part heat dissipation region and the power conversion part heat dissipation region such that the power supply part heat dissipation region projects away from the electric motor in an axial direction of the electric motor with respect to the power conversion part heat dissipation region.

According to a further preferable aspect, the electric power steering device according to one of the foregoing aspects is configured such that the power conversion part heat dissipation region includes a heat dissipation projecting part projecting away from the electric motor in the axial direction of the electric motor.

According to a further preferable aspect, the electric power steering device according to one of the foregoing aspects is configured such that the power conversion circuit part, the power supply circuit part, and the control circuit part of the electronic control part are arranged in this order away from the electric motor in the axial direction of the electric motor.

1. An electric drive device comprising:
a motor housing made of aluminum-based metal and structured to house an electric motor, wherein the motor housing includes an end face part opposite to an output part of a rotating shaft of the electric motor, and wherein the electric motor is structured to drive a controlled object of a mechanical system;
an electronic control part arranged at the end face part of the motor housing, and configured to drive the electric motor, wherein the electronic control part includes a control circuit part, a power supply circuit part, and a power conversion circuit part; and
a metal cover made of aluminum-based metal and structured to cover the electronic control part; wherein
one of the metal cover and the end face part of the motor housing includes an outer peripheral surface including a stepped portion having a radially inward recess form extending annularly;
the stepped portion includes a fit portion where an opening portion of the metal cover is fitted; and
the fit portion is formed with a friction stir welding portion where the motor housing and the metal cover are welded together.

2. The electric drive device according to claim 1, wherein:
the end face part of the motor housing includes the outer peripheral surface including the stepped portion;
the stepped portion includes a stepped portion side wall and a stepped portion bottom wall, wherein the stepped portion side wall is recessed radially inwardly, and wherein the stepped portion bottom wall connects the stepped portion side wall to a lateral peripheral surface part of the end face part;
the opening portion of the metal cover is fitted with the stepped portion by spigot fitting; and
the friction stir welding portion has a central region where the stepped portion bottom wall and the opening portion of the metal cover are in contact with each other.

3. The electric drive device according to claim 2, wherein the friction stir welding portion extends in a region of contact between the stepped portion bottom wall and a distal end of the opening portion of the metal cover, and in a region of contact between the stepped portion side wall and part of an inner periphery of the opening portion of the metal cover.

4. The electric drive device according to claim 2, wherein:
the end face part of the motor housing includes a power conversion part heat dissipation region and a power supply part heat dissipation region;
the power conversion circuit part is mounted to the power conversion part heat dissipation region in a manner to allow generated heat of the power conversion circuit part to be transferred to the motor housing via the power conversion part heat dissipation region; and
the power supply circuit part is mounted to the power supply part heat dissipation region in a manner to allow generated heat of the power supply circuit part to be transferred to the motor housing via the power supply part heat dissipation region.

5. The electric drive device according to claim 4, wherein the end face part of the motor housing includes a step between the power supply part heat dissipation region and the power conversion part heat dissipation region such that the power supply part heat dissipation region projects away from the electric motor in an axial direction of the electric motor with respect to the power conversion part heat dissipation region.

6. The electric drive device according to claim 5, wherein the power conversion part heat dissipation region includes a heat dissipation projecting part projecting away from the electric motor in the axial direction of the electric motor.

7. The electric drive device according to claim 6, wherein the power conversion circuit part, the power supply circuit part, and the control circuit part of the electronic control part are arranged in this order away from the electric motor in the axial direction of the electric motor.

8. An electric power steering device comprising:
an electric motor structured to apply a steering assist force to a steering shaft, depending on an output from a torque sensor, wherein the torque sensor is structured to sense a direction of rotation of the steering shaft and a rotating torque applied to the steering shaft;
a motor housing structured to house the electric motor, wherein the motor housing includes an end face part opposite to an output part of a rotating shaft of the electric motor;
an electronic control part arranged at the end face part of the motor housing, and configured to drive the electric motor, wherein the electronic control part includes a control circuit part, a power supply circuit part, and a power conversion circuit part;
a metal cover made of aluminum-based metal and structured to cover the electronic control part; wherein
one of the metal cover and the end face part of the motor housing includes an outer peripheral surface including a stepped portion having a radially inward recess form extending annularly;
the stepped portion includes a fit portion where an opening portion of the metal cover is fitted; and
the fit portion is formed with a friction stir welding portion where the motor housing and the metal cover are welded together.

9. The electric power steering device according to claim 8, wherein:
the end face part of the motor housing includes the outer peripheral surface including the stepped portion;
the stepped portion includes a stepped portion side wall and a stepped portion bottom wall, wherein the stepped portion side wall is recessed radially inwardly, and wherein the stepped portion bottom wall connects the stepped portion side wall to a lateral peripheral surface part of the end face part;
the opening portion of the metal cover is fitted with the stepped portion by spigot fitting; and
the friction stir welding portion has a central region where the stepped portion bottom wall and the opening portion of the metal cover are in contact with each other.

10. The electric power steering device according to claim 9, wherein the friction stir welding portion extends in a region of contact between the stepped portion bottom wall and a distal end of the opening portion of the metal cover, and in a region of contact between the stepped portion side wall and part of an inner periphery of the opening portion of the metal cover.

11. The electric power steering device according to claim 10, wherein:
the end face part of the motor housing includes a power conversion part heat dissipation region and a power supply part heat dissipation region;
the power conversion circuit part is mounted to the power conversion part heat dissipation region in a manner to allow generated heat of the power conversion circuit part to be transferred to the motor housing via the power conversion part heat dissipation region; and
the power supply circuit part is mounted to the power supply part heat dissipation region in a manner to allow generated heat of the power supply circuit part to be transferred to the motor housing via the power supply part heat dissipation region.

12. The electric power steering device according to claim 11, wherein the end face part of the motor housing includes a step between the power supply part heat dissipation region and the power conversion part heat dissipation region such that the power supply part heat dissipation region projects away from the electric motor in an axial direction of the electric motor with respect to the power conversion part heat dissipation region.

13. The electric power steering device according to claim 12, wherein the power conversion part heat dissipation region includes a heat dissipation projecting part projecting away from the electric motor in the axial direction of the electric motor.

14. The electric power steering device according to claim 13, wherein the power conversion circuit part, the power supply circuit part, and the control circuit part of the electronic control part are arranged in this order away from the electric motor in the axial direction of the electric motor.
